(19) United States
(12) Patent Application Publication
(10) Pub. No.: US 2024/0373285 A1
(43) Pub. Date: Nov. 7, 2024

(54) RADIO ACCESS NETWORK (RAN) CONGESTION DETECTION AND REPORTING FOR LOW-LATENCY SERVICES IN WIRELESS COMMUNICATION NETWORKS

(71) Applicant: T-MOBILE INNOVATIONS LLC, Overland Park, KS (US)

(72) Inventors: Zheng Cai, Fairfax, VA (US); Zheng Fang, McLean, VA (US)

(21) Appl. No.: 18/310,050

(22) Filed: May 1, 2023

(51) Int. Cl. H04W 28/02; H04W 24/10

(52) U.S. Cl. CPC H04W 28/0289; H04W 24/10

(57) ABSTRACT

Various embodiments comprise a wireless access node to inhibit access point data congestion. In some examples, the wireless communication network comprises node circuitry and radio circuitry. The radio circuitry wirelessly exchanges user data with a wireless user device for a low latency data service. The node circuitry exchanges the user data with a network user plane. The node circuitry measures a queue status for downlink data transmission to the wireless user device. The node circuitry generates a queue report that indicates the queue status. The radio circuitry wirelessly transfers the queue report to the wireless user device. The wireless user device receives the queue report and wirelessly transfers uplink signaling indicating the queue report to the wireless access node for delivery to a congestion control application server.

### TECHNICAL FIELD

Various embodiments of the present technology relate to Mobile Edge Computing (MEC), and more specifically, to Radio Access Network (RAN) congestion control for low latency data services.

### BACKGROUND

Wireless communication networks provide wireless data services to wireless user devices. Exemplary wireless data services include machine-control, internet-access, media-streaming, online gaming, and social-networking. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Low Latency, Low Loss, Scalable Throughput (L4S) in a network architecture that enables applications to receive low latency and high data rate communications with dynamic rate adaption for a stable Quality-of-Experience (QoE). Maintaining stable QoE is important for preserving the user experience in latency sensitive L4S applications like Extended Reality (XR), Mixed Reality (MR), Augmented Reality (AR), and Virtual Reality (VR) applications. L4S systems utilize dynamic rate adaption algorithms at the application layer to ensure the latency requirements for the L4S applications are met. The dynamic rate adaption algorithms take network data congestion, particularly RAN data congestion, as an input to generate a congestion control output. The congestion control output modifies the network traffic pattern to preserve latency. Existing systems to detect network data congestion like Explicit Congestion Notification (ECN) are expensive. Moreover, due to the large number of RANs in wireless communication networks, implementing expensive congestion detection systems like ECN is not practical.

Unfortunately, wireless communication networks do not efficiently detect data congestion in RANs for L4S congestion control. Moreover, the wireless communication networks do not effectively communicate RAN congestion status to congestion control systems.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions to detect downlink data congestion in Radio Access Networks (RANs). Some embodiments comprise a method of operating a wireless access node to inhibit access point data congestion. The method comprises wirelessly exchanging user data with a wireless user device for a low latency data service. The method further comprises exchanging the user data with a network user plane. The method further comprises measuring a queue status for downlink data transmission to the wireless user device. The method further comprises generating a queue report that indicates the queue status. The method further comprises wirelessly transferring the queue report to the wireless user device. The wireless user device receives the queue report and wirelessly transfers uplink signaling indicating the queue report to the wireless access node for delivery to a congestion control application server.

Some embodiments comprise a wireless access node to inhibit access point congestion. The wireless access node comprises node circuitry and radio circuitry. The radio circuitry wirelessly exchanges user data with a wireless user device for a low latency data service. The node circuitry exchanges the user data with a network user plane. The node circuitry measures a queue status for downlink data transmission to the wireless user device. The node circuitry generates a queue report that indicates the queue status. The radio circuitry wirelessly transfers the queue report to the wireless user device. The wireless user device receives the queue report and wirelessly transfers uplink signaling indicating the queue report to the wireless access node for delivery to a congestion control application server.

Some embodiments comprise a method of operating a wireless communication network to inhibit downlink congestion for Low Latency, Low Loss, Scalable (L4S) data services. The method comprises a Radio Access Network (RAN) wirelessly exchanging user data with a wireless User Equipment (UE) for a low latency data service and exchanging the user data with a network user plane. The method further comprises the RAN measuring a queue status for downlink data transmission to the wireless UE, generating a queue report that indicates the queue status, and wirelessly transferring the queue report to the wireless UE. The method further comprises the wireless UE receiving the queue report and wirelessly transferring uplink signaling indicating the queue report to the RAN for delivery to a congestion control application server. The method further comprises the RAN receiving the queue report and forwarding the queue report to the congestion control application server. The method further comprises the congestion control application server receiving the queue report and implementing a congestion control algorithm based on the queue report.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a wireless communication network to inhibit access point congestion.

FIG. 2 illustrates an exemplary operation of the wireless communication network to inhibit access point congestion.

FIG. 3 illustrates a wireless communication network to inhibit downlink congestion for Low Latency, Low Loss, Scalable (L4S) data services.

FIG. 4 illustrates an exemplary operation of the wireless communication network to inhibit downlink congestion for L4S data services.

FIG. 5 illustrates an exemplary operation of the wireless communication network to inhibit downlink congestion for L4S data services.

FIG. 6 illustrates a Fifth Generation (5G) wireless communication network to inhibit downlink congestion for L4S data services.

FIG. 7 illustrates the 5G UE in the 5G communication network.

FIG. 8 illustrates a 5G Radio Access Network (RAN) in the 5G wireless communication network.

FIG. 9 illustrates an Edge Data Network (EDN) in the 5G wireless communication network.

FIG. 10 illustrates a Network Function Virtualization Infrastructure (NFVI) and an Application Server (AS) in the 5G wireless communication network.

FIG. 11 further illustrates the EDN, the NFVI, and the AS in the 5G wireless communication network.

FIG. 12 illustrates an exemplary operation of the 5G wireless communication network to inhibit downlink congestion for L4S data services.

FIG. 13 illustrates an exemplary operation of the 5G wireless communication network to inhibit downlink congestion for L4S data services.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

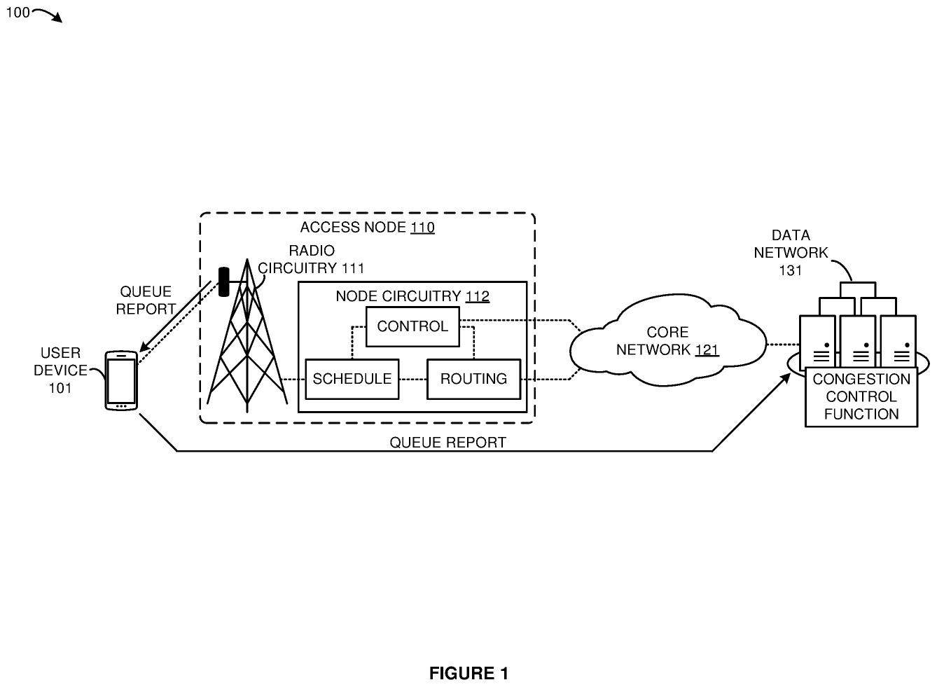

FIG. 1 illustrates wireless communication network 100 network to inhibit access point congestion. Wireless communication network 100 delivers services like machine communications, internet-access, media-streaming, or some other wireless communications product to user devices. Wireless communication network 100 comprises user device 101, access node 110, core network 121, and data network 131. Access node 110 comprise radio circuitry 111 and node circuitry 112. Node circuitry 112 comprises network applications for node control, data scheduling, and data routing. In other examples, wireless network communication network 100 may comprise additional or different elements than those illustrated in FIG. 1.

Various examples of network operation and configuration are described herein. In some examples, radio circuitry 111 wirelessly exchanges user data for a low latency with user device 101. Node circuitry 112 exchanges the user data with core network 121. Core network 121 exchanges the user data with data network 131. For example, node circuitry 112 may exchange the user data with a low latency capable user plane in core network 121 for delivery to data network 131. Node circuitry 112 measures a queue status for the downlink data transmission. For example, the scheduling application in node circuitry 112 may detect there exists more downlink data to transmit than available air resources. Node circuitry 112 generates a queue report that indicates the queue status. Radio circuitry 111 wirelessly transfers the queue report to user device 101. User device 101 receives and processes the queue report. User device 101 generates uplink signaling that indicates the queue report and wirelessly transfers the uplink signaling to access node for delivery to data network 131. Radio circuitry 111 wirelessly receives the uplink signaling and node circuitry 112 transfers the uplink signaling to data network 131 over core network 121. Data network 131 receives and process the uplink signaling to detect the queue report. Data network 131 executes a congestion control function based on the queue report. For example, the queue report may indicate the existence of a data queue in access node 110 and an unsatisfactory downlink data rate to user device 101. In response, data network 131 may reduce the amount of downlink data sent towards core network 121 to alleviate the data queue.

Wireless communication network 100 provides wireless data services to user device 101. Exemplary user devices include phones, computers, vehicles, robots, and sensors. Access node 110 exchanges wireless signals with user device 101 over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). Access node 110 is connected to core network 121 over backhaul data links. Access node 110 exchanges network signaling and user data with network elements in core network 121. Access node 110 may comprise wireless access points, Radio Access Networks (RANs), edge computing systems, or other types of wireless/wireline access systems to provide wireless/wireline links to user device 101, the backhaul data links, and edge computing services between user device 101 and core network 121.

Access node 110 may comprise Radio Units (RUS), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 121. The CUS handle higher wireless network layers like the Radio Resource Control (RRC), Service Data Adaption Protocol (SDAP), and Packet Data Convergence Protocol (PDCP). The CUs are coupled to network functions in core network 121.

Core network 121 and data network 131 are representative of computing systems that provide wireless data services to user device 101 over access node 110. Exemplary computing systems comprise data centers, edge computing networks, cloud computing networks, and the like. The computing systems of core network 121 store and execute the network functions to provide wireless data services to user device 101 over access node 110. Exemplary network functions include Access and Mobility Management Function (AMF), Session Management Function (SMF), and User Plane Function (UPF). Core network 121 may comprise a Fifth Generation Core (5GC) architecture and/or an Evolved Packet Core (EPC) architecture.

The computing systems of data network 131 store and execute applications to provide low latency data services and to implement congestion control functionality. In response to receiving the queue report generated by node circuitry 112 and sent from user device 101, data network 131 implements a congestion control algorithm. The congestion control algorithm receives inputs from the queue report like queue existence, queued data amount, current data rate, delta between current data rate and expected data rate, and the like. The congestion control algorithm generates an output to alleviate downlink access node congestion based on the set of inputs indicated queue report. For example, the congestion control output may comprise a reduction in downlink data transfer by the data network 131 to reduce the amount of queued data in access node 110 and preserve the service latency to user device 101.

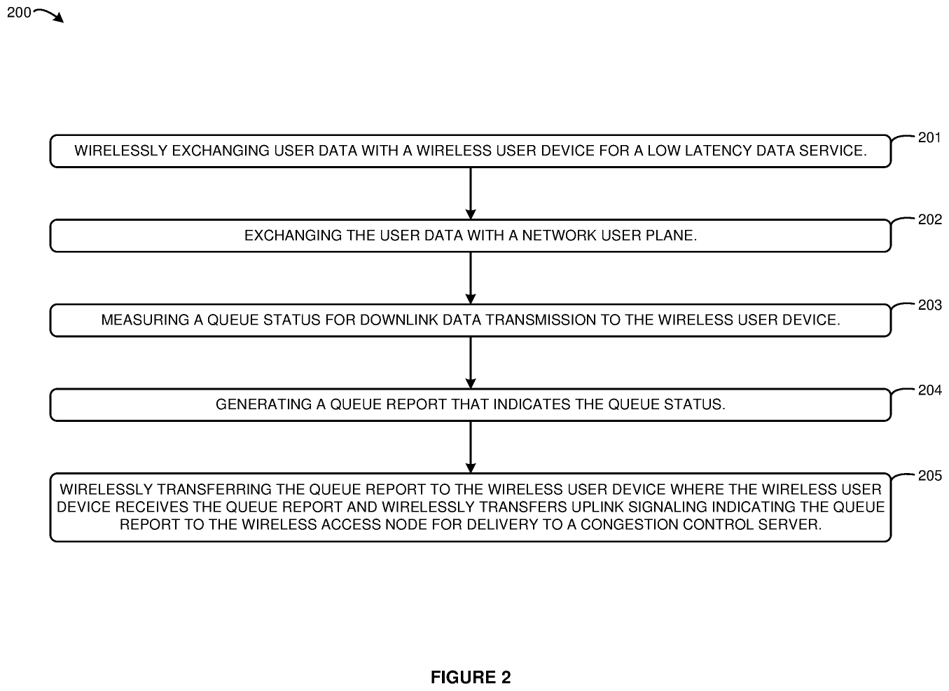

FIG. 2 illustrates process 200. Process 200 comprises an exemplary operation of wireless communication network 100 to inhibit access point congestion. The operation may vary in other examples. The operations of process 200 comprise wirelessly exchanging user data with a wireless user device for a low latency data service (step 201). The operations further comprise exchanging the user data with a network user plane (step 202). The operations further comprise measuring a queue status for downlink data transmission to the wireless user device (step 203). The operations further comprise generating a queue report that indicates the queue status (step 204). The operations further comprise wirelessly transferring the queue report to the wireless user device (step 205). The wireless user device receives the queue report and wirelessly transfers uplink signaling indicating the queue report to the wireless access node for delivery to a congestion control server.

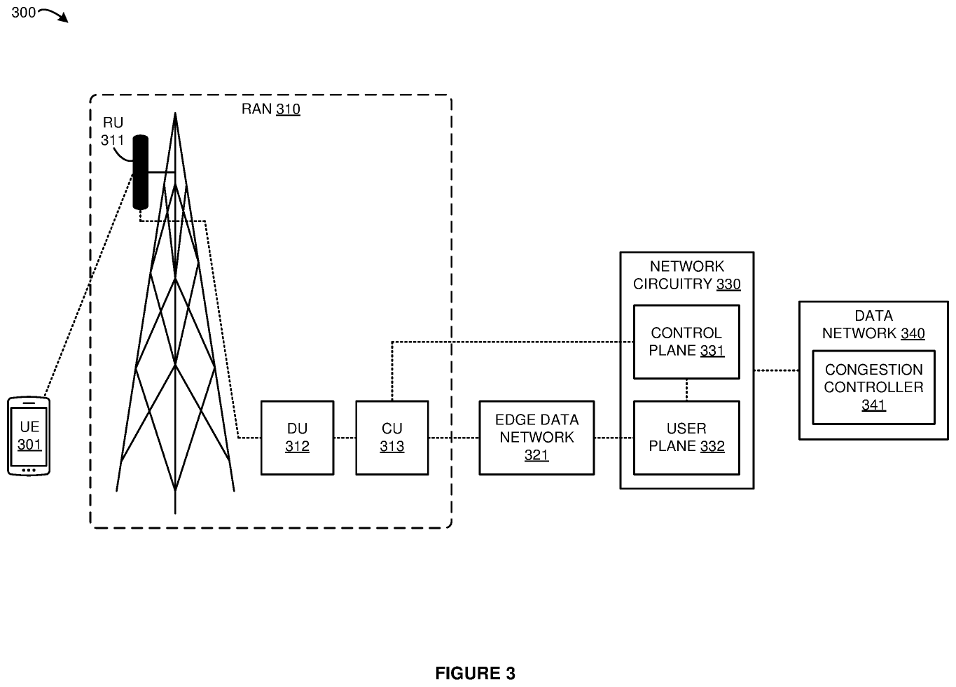

FIG. 3 illustrates wireless communication network 300 network to inhibit downlink congestion for Low Latency, Low Loss, Scalable (L4S) data services. Wireless communication network 300 is an example of wireless network 100, however network 100 may differ. Wireless communication network 300 comprises UE 301, RAN 310, Edge Data Network (EDN) 321, network circuitry 330, and data network 340. RAN 310 comprises RU 311, DU 312, and CU 313. Network circuitry 330 comprises control plane 331 and user plane 332. Data network 340 comprises congestion controller 341. In other examples, wireless network 300 may comprise additional or different elements than those illustrated in FIG. 3.

In some examples, UE 301 attaches to RAN 310. UE 301 exchanges attachment signaling with DU 312, CU 313, and control plane 331 to register itself with network circuitry 330. Upon registration, UE 301 executes an L4S application client and responsively transfers a request for L4S data services to control plane 331 over RAN 310. For example, the L4S application client may comprise a metaverse application, an Extended Reality (XR) application, a Mixed Reality (MR) application, an Augmented Reality (AR), application, a Virtual Reality (VR) application, and the like. Control plane 331 interfaces with user plane 332, EDN 321, and data network 340 to establish the L4S data session. EDN 321 executes an L4S application that corresponds to the L4S application client in UE 301. In some examples, a portion of the L4S application executes in EDN 321 while another portion of the L4S application executes in data network 340. EDN 321 generates downlink data for the L4S session and transfers the downlink data to CU 313. CU 313 transfers the downlink data to UE 301 over DU 312 and RU 311. UE 301 generates uplink data for the L4S session and transfers the uplink data to CU 313 over RU 311 and DU 312. CU 313 transfers the uplink data to EDN 321.

DU 312 measures a downlink data queue status for the data session. For example, DU 312 may determine if a downlink data queue exists, the amount of queued downlink data, the current downlink data rate, a delta between the current downlink data rate and an expected downlink data rate, a queue time, current latency, and/or other metrics characterizing downlink data congestion in RAN 310. Generally, a downlink data queue forms when a greater amount of downlink data is transmitted by EDN 321 for delivery to UE 301 than an amount of available air resources to transmit the data to UE 301. DU 312 generates a queue report that indicates the measured queue status. For example, the queue report may comprise an indication that the downlink data queue exists, the amount of queued downlink data, the current downlink data rate, a delta between the current downlink data rate and an expected downlink data rate, a queue time, a latency, and/or other metrics characterizing downlink data congestion in RAN 310. DU 312 transfers the queue report to UE 301 over RU 311. UE 301 detects the queue report and associates the queue report with the L4S application client. UE 301 generates uplink signaling that comprises the queue report. UE 301 transfers the uplink signaling comprising the queue report for delivery to data network 340. UE 301 may transfer the queue report in control plane uplink signaling along a signaling path that traverses RAN 310, control plane 321, and data network 340. Alternatively, UE 310 may transfer the queue report in user plane uplink signaling along a signaling path that traverses RAN 310, EDN 321, user plane 332, and data network 340.

RAN 310 receives the uplink signaling and forwards the signaling for delivery to data network 340 over network circuitry 330. Data network 340 receives the queue report and congestion controller 341 implements a congestion control scheme to alleviate L4S downlink data congestion in RAN 310. For example, congestion controller 341 may execute a congestion control algorithm that uses the congestion data of the queue report as inputs to generate a congestion control output. The congestion control output may comprise a decrease in downlink data transmission, a temporary stoppage of downlink data transmission, an altercation to downlink data rate, and/or some other type of output to reduce the amount of queued data and maintain service latency for UE 301. Exemplary congestion control algorithms include Transmission Control Protocol (TCP) congestion control algorithms like Bottleneck Bandwidth and Round-trip propagation time (BBR).

Advantageously, wireless communication network 300 efficiently detects downlink data congestion in RAN 310. Moreover, wireless communication network 300 effectively transfers queue reports that characterize RAN congestion to congestion controller 341 over the end-to-end communication link between UE 301 and controller 341.

UE 301 and RAN 310 communicate over links using wireless/wired technologies like 5GNR, LTE, LP-WAN, WIFI, Bluetooth, and/or some other type of wireless or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface. RAN 310, EDN 321, network circuitry 330, and data network 340 communicate over various links that use metallic links, glass fibers, radio channels, or some other communication media. The links use Fifth Generation Core (5GC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or some other data communication protocols.

UE 301 may comprise a phone, vehicle, computer, sensor, drone, robot, or another type of data appliances with wireless and/or wireline communication circuitry. Although RAN 310 is illustrated as a tower, RAN 310 may comprise another type of mounting structure (e.g., a building), or no mounting structure at all. RAN 310 comprises a Fifth Generation (5G) RAN, LTE RAN, gNodeB, eNodeB, NB-IoT access node, LP-WAN base station, wireless relay, WIFI hotspot, Bluetooth access node, and/or another wireless or wireline network transceiver. UE 301 and RAN 310 comprise antennas, amplifiers, filters, modulation, analog/digital interfaces, microprocessors, software, memories, transceivers, bus circuitry, and the like. Control plane 331 comprises network functions like AMF, SMF, and the like. User plane 332 comprises network functions like UPF and the like. EDN 321 comprises network functions and entities like edge UPF, Edge Application Server (EAS), Edge Enablement Server (EES), Edge Configuration Server (ECS), Mobile Edge Computing (MEC) applications, MEC platforms, and the like. Data network 340 is representative of a data endpoint that provides a L4S application support for UE. Data network 340 may comprise Application Server (AS), L4S applications, congestion control functions, and the like.

UE 301, RAN 310, EDN 321, network circuitry 330, and data network 340 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, Solid State Drives (SSD), Non-Volatile Memory Express (NVMe) SSDs, Hard Disk Drives (HDDs), and/or the like. The memories store software like operating systems, user applications, radio applications, network functions, and multimedia functions. The microprocessors retrieve the software from the memories and execute the software to drive the operation of wireless communication network 300 as described herein.

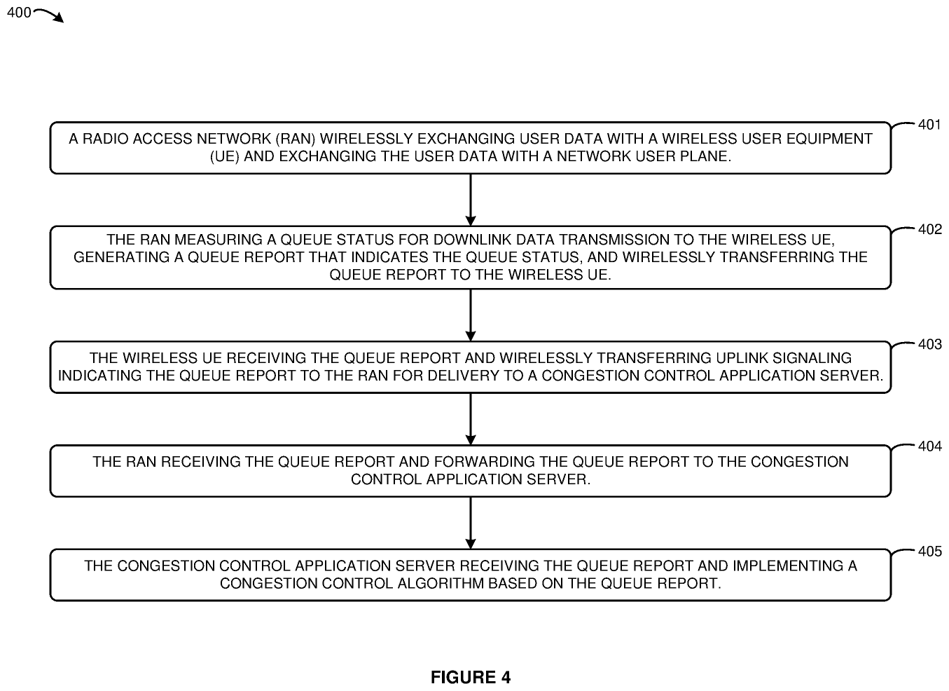

FIG. 4 illustrates process 400. Process 400 comprises an exemplary operation of wireless communication network 300 to inhibit downlink congestion for L4S data services. The operation may vary in other examples. The operations of process 400 comprise a RAN wirelessly exchanging user data with a wireless UE and exchanging the user data with a network user plane (step 401). The operations further comprise the RAN measuring a queue status for downlink data transmission to the wireless UE, generating a queue report that indicates the queue status, and wirelessly transferring the queue report to the wireless UE (step 402). The operations further comprise the wireless UE receiving the queue report and wirelessly transferring uplink signaling indicating the queue report to the RAN for delivery to a congestion control application server (step 403). The operations further comprise the RAN receiving the queue report and forwarding the queue report to the congestion control application server (step 404). The operations further comprise the congestion control application server receiving the queue report and implementing a congestion control algorithm based on the queue report (step 405).

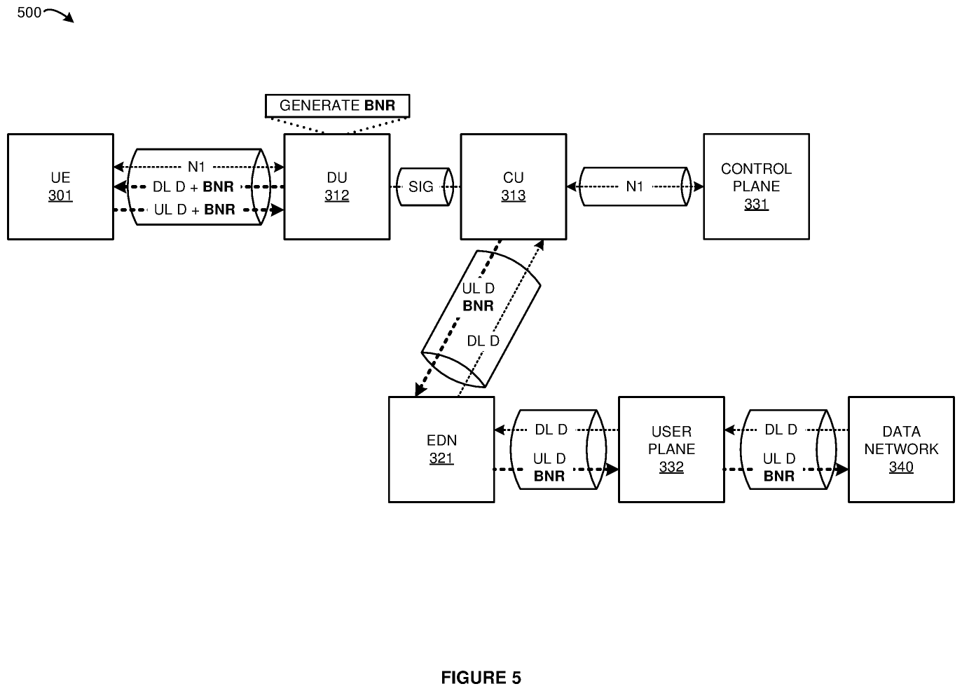

FIG. 5 illustrates process 500. Process 500 comprises an exemplary operation of wireless communication network 300 to inhibit downlink congestion for L4S data services. The operation may vary in other examples. In operation, UE 301 attaches to RAN 310 and establishes a control plane N1 signaling link with control plane 331 in network circuitry 330. The N1 signaling link may traverse an RRC connection between UE 301 and CU 313 and an N2 signaling link between CU 313 and control plane 331. UE 301 interfaces with control plane 331 over the N1 signaling link to request an XR data session. Control plane 331 approves the session request and interfaces with EDN 321, user plane 332, and data network 340 to set up the XR session.

UE 301 executes an XR application client. EDN 321 executes an edge portion of the XR application and data network 340 executes a control portion of the XR application. Data network generates downlink data (DL D) for the XR application and transfers the downlink data to user plane 332 over the signaling link between user plane 332 and data network 340. For example, the signaling link between user plane 332 and data network 340 may comprise an N6 signaling link. User plane 332 forwards the downlink data to EDN 321 over the signaling link between EDN 321 and user plane 332. For example, the signaling link between user plane 332 and EDN 321 may comprise an EDGE signaling link. EDN 321 generates additional downlink data. EDN 321 transfers the downlink data to CU 313 over the signaling link between EDN 321 and CU 313. For example, the signaling link between EDN 321 and CU 313 may comprise another EDGE signaling link. CU 313 transfers the downlink data to UE 301 over a signaling link that traverses DU 312 and RU 311.

Likewise, UE 301 generates uplink data (UL D) for the XR application and transfers the uplink data to CU 313 over the signaling link between UE 301 and CU 313. CU 313 forwards the uplink data to EDN 321 over the signaling link between CU 313 and EDN 321. EDN 321 transfers the uplink data to user plane 332 over the signaling link between EDN 321 and user plane 332. User plane 332 transfers the uplink data to data network 340 over the signaling link between user plane 332 and data network 340.

DU 312 detects a downlink data bottleneck in RAN 310. For example, DU 312 may determine the amount of downlink data received from EDN 321 exceeds the amount of available resource blocks to transfer the downlink data. DU 312 generates a Bottleneck Report (BNR) that characterizes the downlink data congestion in RAN 310. DU 312 transfers the BNR over the downlink data link to UE 301. UE 301 receives the BNR and encodes the BNR in uplink data signaling. UE 301 transfers the BNR over the uplink data link that traverse RAN 310, EDN 321, user plane 332, and data network 340. Congestion controller 341 in data network 340 receives the BNR report. Congestion controller 341 implements a congestion control scheme based on the BNR to alleviate the downlink data congestion in DU 312.

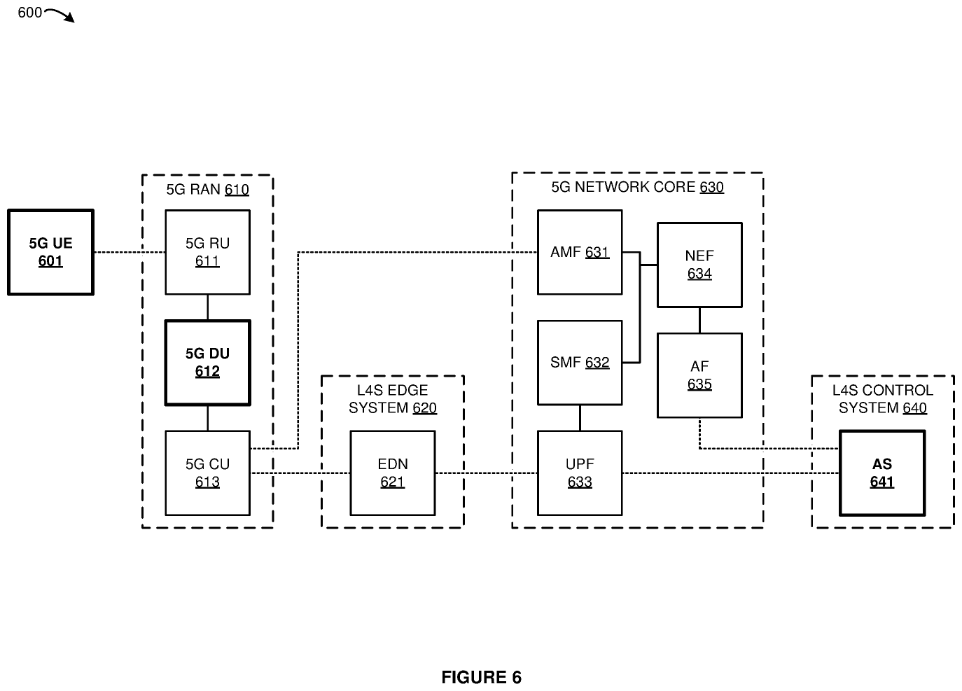

FIG. 6 illustrates 5G communication network 600 to inhibit downlink congestion for L4S data services. 5G communication network 600 comprises an example of wireless communication networks 100 and 300, although networks 100 and 300 may differ. 5G communication network 600 comprises 5G UE 601, 5G RAN 610, L4S edge system 620, 5G network core 630, and L4S control system 640. 5G RAN 610 comprises 5G Radio Unit (RU) 611, 5G Distributed Unit (DU) 612, and 5G Centralized Unit (CU) 613. 5G network core 630 comprises AMF 631, SMF 632, UPF 633, Network Exposure Function (NEF) 634, and Application Function (AF) 635. L4S edge system 620 comprises EDN 621. L4S control system 640 comprises Application Server (AS) 641. Other network functions and network elements are typically present in 5G network core 630 but are omitted for clarity. In other examples, wireless network communication network 600 may comprise additional or different elements than those illustrated in FIG. 6.

UE 601 wirelessly attaches to CU 613 via DU 612 and RU 611. UE 601 exchanges attachment signaling with CU 613 to establish a connection with 5G network applications hosted by CU 613. The attachment signaling indicates information like a registration type, UE capabilities, requested slice types, and Protocol Data Unit (PDU) session requests. CU 613 transfers a registration request for UE 601 to AMF 631. AMF 631 responds to the registration request by transferring an identity request to UE 601 via RAN 610. UE 601 responsively indicates its identity to AMF 631 via RAN 610. AMF 631 interacts with other network functions like Unified Data Management (UDM), Policy Control Function (PCF), and Authentication Server Function (AUSF) to authenticate and authorize UE 601 for wireless data service.

Responsive to the authentication and authorization, AMF 631 generates UE context to establish the wireless data service. For example, AMF 631 may retrieve Quality-of-Service (QOS) metrics, slice Identifiers (IDs), service attributes, and the like from a UDM. AMF 631 interacts with other network functions to select a network slice for UE 601 and selects SMF 632 to serve UE 601 based on the slice ID, QoS metrics, and the service attributes. SMF 632 selects UPF 633 based on the service information provided. SMF 632 indicates the network addresses for UPF 633 to AMF 631. AMF 631 generates UE context for UE 601 using the received information. The UE context comprises the QoS metrics, the slice ID, the network addresses, the service attributes, and the like. AMF 631 transfers the UE context to UE 601 over RAN 610.

In response to receiving a user input, UE 601 executes an L4S application. For example, UE 601 may execute an XR application, MR application, VR application, AR application, or some other type of latency sensitive application. UE 601 transfers a PDU request for the L4S application to AMF 631 over RAN 610. AMF 631 receives the PDU session request and forwards the request to SMF 632. SMF 632 interfaces with UPF 633, EDN 621, and AS 641 to set up the requested L4S PDU session. EDN 621 spins up a corresponding L4S application to server the PDU session. SMF 632 generates session context that comprises network addresses for EDN 621, UPF 633, and AS 641. SMF 632 transfers the session context to UE 601 over RAN 610. UE 601 exchanges user data for the L4S session with CU 613 over RU 611 and DU 612 based on the session context. CU 613 exchanges the user data with EDN 621. EDN 621 exchanges the user data with AS 641 over UPF 633.

During the L4S PDU session, DU 612 monitors downlink data RAN congestion. To monitor downlink congestion, DU 612 identifies when a data queue forms. Typically, this occurs when the number of required resource blocks to transmit the downlink data is less than the number of available resource blocks. For example, DU 612 may host a data structure that compares the required resource blocks to the available resource blocks to determine when a queue exists. When DU 612 identifies the existence of a queue, DU 612 measures various queue attributes to generate a BNR characterizing the queue. DU 612 determines the amount of queued data, the current data rate, a delta between expected and current data rate, estimated delay time, latency, and/or other queue attributes. DU 612 generates a BNR that indicates the presence of the queue and the measured queue attributes. Generally, the queue attributes measured by DU 612 correspond to the algorithm inputs used by the congestion control algorithm implemented by AS 441. DU 612 transfers the BNR to UE 601. Since RAN 610 is end-point agnostic, DU 612 efficiently utilizes the established end-to-end signaling link between UE 601 and AS 641 to route the BNR to its intended destination. DU 612 may generate BNRs periodically, semi-periodically, randomly, and/or in response to detecting a queue to inform AS 641 of the congestion status of RAN 610. For example, DU 612 may generate and transfer a BNR once every ten minutes.

UE 601 wirelessly receives the BNR from RAN 610. UE 601 associates the BNR with the L4S data session. For example, UE 601 may read a message header indicating the BNR and in response, associate the BNR with the L4S session. UE 601 retrieves the network address for AS 641 from the session context. UE 601 generates uplink user plane signaling comprising the BNR and wirelessly transfers the BNR to RAN 610 for delivery to AS 641. RAN 610 receives the uplink signaling and transfers the uplink user plane signaling to EDN 621. EDN 621 forwards the uplink user plane signaling to AS 641 over UPF 633. AS 641 receives the uplink signaling and detects the BNR. AS 641 executes a congestion control algorithm that uses the queue information in the BNR as inputs to generate a congestion control output. AS 641 receives the output from the congestion control algorithm and implements the congestion control response based on the output. For example, the congestion control algorithm may comprise a BBR algorithm that takes current latency, amount of queued data, queuing delay, and current data bit rate as inputs to generate a congestion response output. Exemplary congestion responses include decreasing downlink data transfer, altering downlink data scheduling, modifying downlink data bit rate, and/or some other type of congestion response to maintain the latency requirements of the L4S session and maintain the Quality-of-Experience (QoE) for the user. It should be appreciated that the type of congestion response depends on the type of congestion control algorithm used by AS 641 and that the type of congestion control algorithm is not limited.

In some examples, UE 601 may lack the address information (e.g., the network address for AS 641) to transfer the BNR report to implement the congestion control scheme. When UE 601 does not have the requisite address information, UE 601 instead relies on the network exposure capabilities of network core 630. In these examples, UE 601 wirelessly receives the BNR from RAN 610 and associates the BNR with the L4S data session. UE 601 processes the session context and determines it lacks the network address for the BNR message destination. UE 601 generates uplink control plane signaling comprising the BNR and wirelessly transfers the BNR to RAN 610 for delivery to AMF 631. RAN 610 receives the uplink control plane signaling and transfers the uplink control plane signaling to AMF 631. AMF 631 interfaces with NEF 634 to expose the BNR to the indented third-party system. NEF 634 determines the BNR is associated with L4S control system 640 and exposes the BNR to AS 641 via AF 635. For example, NEF 634 may query a network data system (e.g., a UDM) for subscriber information for UE 601 to associate the BNR with L4S control system 640.

In some examples, L4S control system 640 and AS 641 may be absent from 5G wireless communication network 600. The operations of AS 641, including the congestion control functionality, may instead be performed by EDN 621.

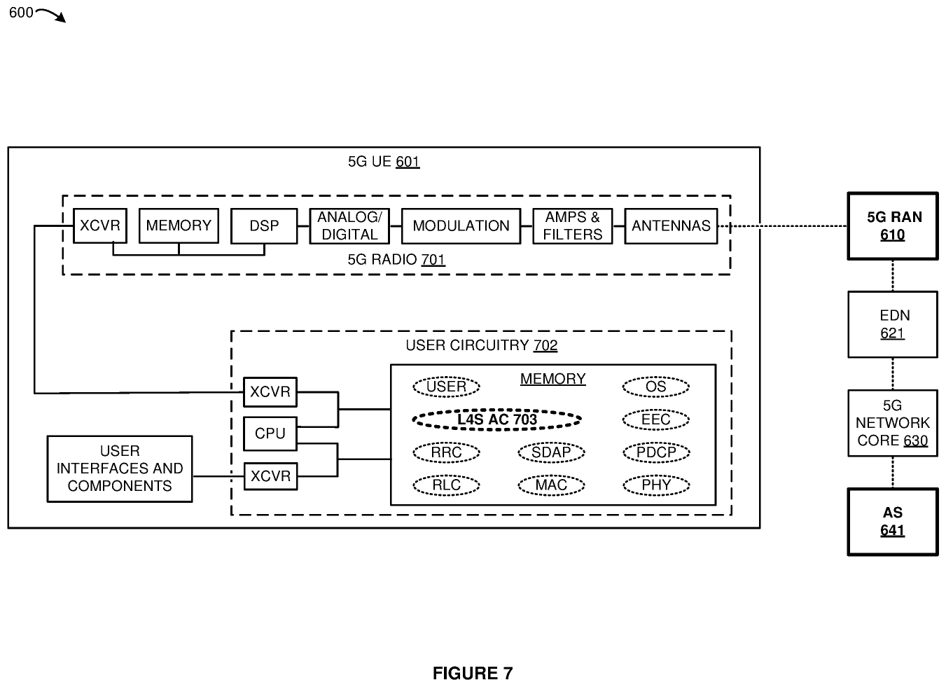

FIG. 7 illustrates 5G UE 601 in 5G communication network 600. UE 601 comprises an example of user device 101 illustrated in FIG. 1 and UE 301 illustrated in FIG. 3, however user device 101 and UE 301 may differ.

UE 601 comprises 5G radio 701 and user circuitry 702. Radio 701 comprises antennas, amplifiers, filters, modulation, analog-to-digital interfaces, Digital Signal Processers (DSP), memory, and transceivers (XCVRs) that are coupled over bus circuitry. User circuitry 702 comprises memory, CPU, user interfaces and components, and transceivers that are coupled over bus circuitry. The memory in user circuitry 702 stores an operating system (OS), user applications (USER), and 5GNR network applications for Physical Layer (PHY), Media Access Control (MAC), Radio Link Control (RLC), Packet Data Convergence Protocol (PDCP), Service Data Adaptation Protocol (SDAP), Radio Resource Control (RRC), L4S Application Client (AC) 703, and Edge Enablement Client (EEC). The antenna in radio 701 is wirelessly coupled to 5G RAN 610 over a 5GNR link. A transceiver in radio 701 is coupled to a transceiver in user circuitry 702. A transceiver in user circuitry 702 is typically coupled to the user interfaces and components like displays, controllers, and memory.

In radio 701, the antennas receive wireless signals from 5G RAN 610 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 702 over the transceivers. In user circuitry 702, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In radio 701, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 610 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, QoS. PHY functions comprise packet formation/deformation, windowing/de-windowing, guard-insertion/guard-deletion, parsing/de-parsing, control insertion/removal, interleaving/de-interleaving. Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs). L4S AC 703 functions comprise BNR detection and providing L4S application services like XR services, MR service, VR services, and/or AR services. EEC functions comprise retrieving configuration information to enable the exchange of application data with an Edge Application Server (EAS), discovering available EASs, and detecting UE mobility events.

In some examples, UE 601 executes L4S AC 703 in response to user input to receive L4S services. For example, L4S AC 703 may comprise an XR metaverse application and UE 601 may execute L4S AC 703 to begin an XR metaverse session. L4S AC 703 receives downlink data for the L4S session and detects the BNR transferred by DU 612. When L4S AC 703 detects the BNR, L4S AC 703 generates uplink user data that includes the BNR and addresses the uplink data for a congestion control system associated with the L4S session. For example, when the congestion control system is resident in AS 641, L4S AC 703 addresses the uplink data with the BNR for AS 641. For example, when the congestion control system is resident in EDN 621, L4S AC 703 addresses the uplink data with the BNR for EDN 621. UE 601 executes the other network applications like SDAP, PDCP, RLC, MAC, and PHY to transfer the uplink user data generated by L4S AC 703 to wirelessly transfer the BNR.

In some examples, L4S AC 703 may be unaware of the of the network location of the congestion control system. In this case, when L4S AC 703 detects the BNR, L4S AC 703 indicates the BNR to the RRC in UE 601. The RRC generates control plane signaling to report the BNR to the control plane elements of network core 630 (e.g., AMF 631) which can then expose the BNR to the appropriate congestion control system through NEF 634 and AF 635. UE 601 executes the other network applications like PDCP, RLC, MAC, and PHY to transfer the uplink control plane signaling generated by the RRC to wirelessly transfer the BNR.

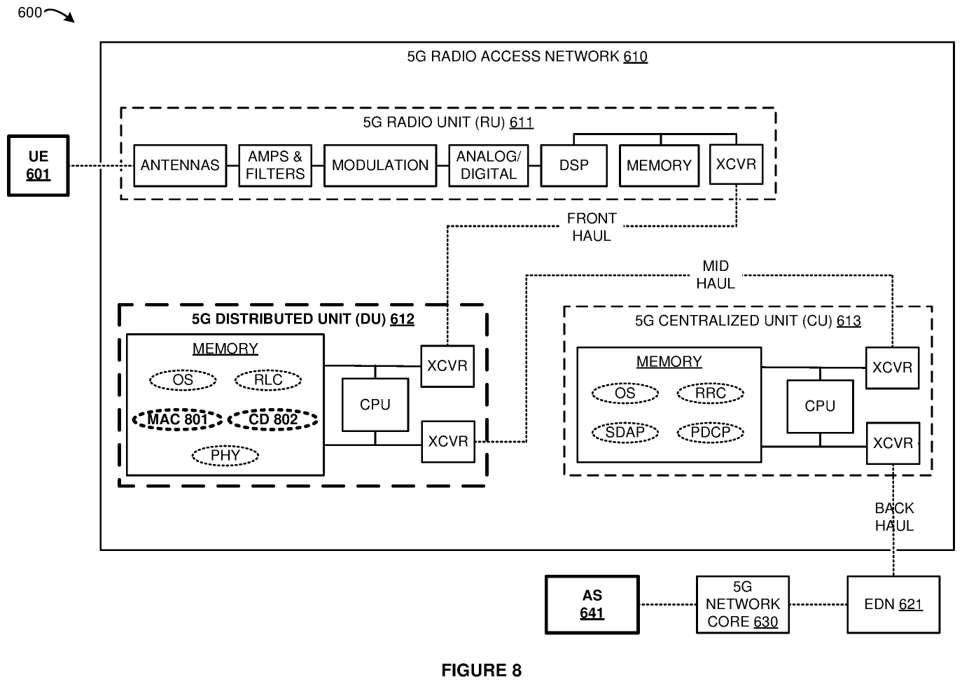

FIG. 8 illustrates 5G RU 611, 5G DU 612, and 5G CU 613 in 5G communication network 600. RU 611, DU 612, and CU 613 comprise an example of access node 110 illustrated in FIG. 1 and RAN 310 illustrated in FIG. 3, however access node 110 and RAN 310 may differ.

RU 611 comprises antennas, amplifiers, filters, modulation, analog-to-digital interfaces, DSP, memory, and transceivers (XCVRs) that are coupled over bus circuitry. UE 601 is wirelessly coupled to the antennas in RU 611 over 5GNR links. Transceivers in 5G RU 611 are coupled to transceivers in 5G DU 612 over fronthaul links like enhanced Common Public Radio Interface (eCPRI). The DSPs in RU 611 executes their operating systems and radio applications to exchange 5GNR signals with UE 601 and to exchange 5GNR data with DU 612.

For the uplink, the antennas receive wireless signals from UE 601 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 612 over the transceivers.

For the downlink, the DSPs receive downlink 5GNR symbols from DU 612. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 601 that transport the downlink 5GNR signaling and data.

DU 612 comprises memory, CPU, and transceivers that are coupled over bus circuitry. The memory in 5G DU 612 stores operating systems and 5GNR network applications like PHY, MAC 801, Congestion Detection (CD) 802 and RLC. CU 613 comprises memory, CPU, and transceivers that are coupled over bus circuitry. The memory in CU 613 stores an operating system and 5GNR network applications like PDCP. SDAP, and RRC. Transceivers in 5G DU 612 are coupled to transceivers in RU 611 over front-haul links. Transceivers in DU 612 are coupled to transceivers in CU 613 over mid-haul links. A transceiver in CU 613 is coupled to network core 630 over backhaul links.

RLC functions comprise ARQ, sequence numbering and resequencing, segmentation and resegmentation. MAC 801 functions comprise buffer status, power control, channel quality, HARQ, user identification, random access, user scheduling, QoS, and BNR generation. CD 802 functions include congestion detection and queue measuring. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping. FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

In some examples, MAC 801 schedules downlink user data for an L4S data session for UE 601. The PHY transfers downlink resource blocks based on the scheduling provided by MAC 801 to transfer the downlink user data to UE 601. The radio circuitry in RU 611 wirelessly transfers the downlink resource blocks to UE 601. CD 802 monitors the queueing status for the downlink data transfer. CD 802 compares the amount of available downlink resource blocks to the amount of required downlink resource blocks for a given time interval. CD 802 determines the existence of a data queue when the amount of required resource blocks exceeds the amount of available resource blocks for the time interval. For example, CD 802 may determine MAC 801 can schedule 50 resource blocks in the next 50 ms, that 100 resource blocks worth of downlink data needs to be transferred in the next 50 ms, and responsively determine the existence of a data queue. When CD 802 detects the existence of the downlink queue, CD 802 measures queue attributes like queue size, latency, downlink data rate, estimated queue time, amount of queued L4S data for UE 601, and the like. CD 802 indicates the existence of the queue and the measured queue attributes to MAC 801. MAC 801 generates the BNR based on the queue measurements and schedules the BNR for wireless transmission to UE 601. The PHY in transfers downlink resource blocks that include the BNR based on the scheduling provided by MAC 801. The radio circuitry in RU 611 wirelessly transfers the downlink resource blocks with the BNR to UE 601 for delivery to the congestion control system in AS 641 and/or EDN 621.

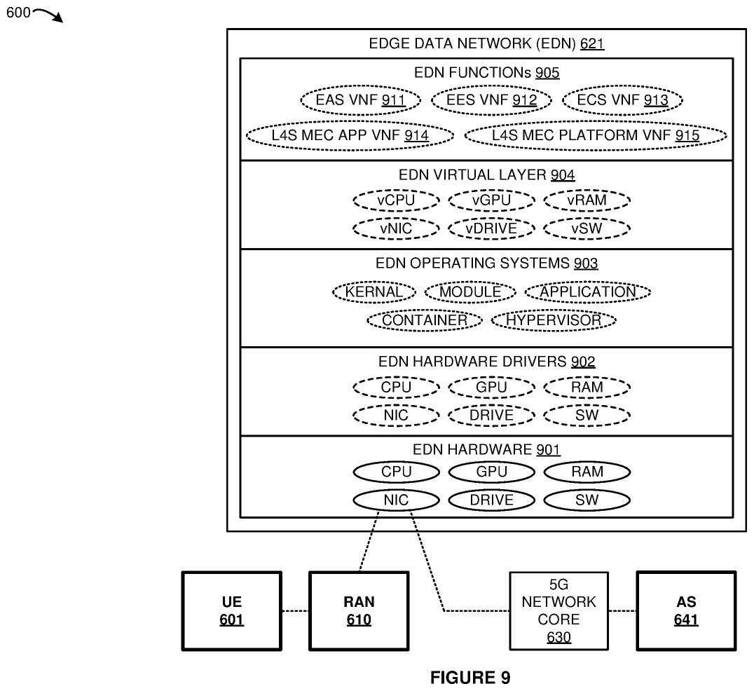

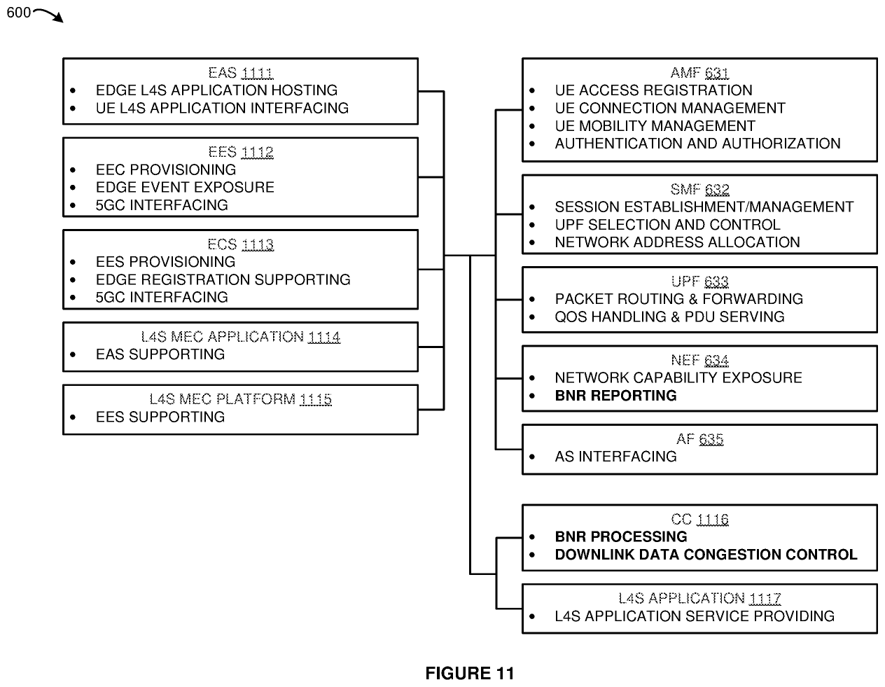

FIG. 9 illustrates EDN 621. EDN 621 comprises an example of EDN 321 illustrated in FIG. 3, although EDN 321 may differ. EDN 621 comprises EDN hardware 901, EDN hardware drivers 902, EDN operating systems 903, EDN virtual layer 904, and EDN function 905. EDN hardware 901 comprises Network Interface Cards (NICs), CPU, GPU, RAM, Flash/Disk Drives (DRIVE), and Data Switches (SW). EDN hardware drivers 902 comprise software that is resident in the NIC, CPU, GPU, RAM, DRIVE, and SW. EDN operating systems 903 comprise kernels, modules, applications, containers, hypervisors, and the like. EDN virtual layer 904 comprises vNIC, vCPU, vGPU, vRAM, vDRIVE, and vSW. EDN functions 905 comprise Edge Application Server (EAS) Virtual Network Function (VNF) 911, Edge Enabler Server (EES) VNF 912, Edge Configuration Server (ECS) VNF 913, L4S Mobile Edge Computing (MEC) application (APP) VNF 914, and L4S MEC platform VNF 915. Additional EDN VNFs and network elements like additional EAS VNFs or EES VNFs are typically present but are omitted for clarity. EDN 621 may be located at a single site or be distributed across multiple geographic locations. The NIC in EDN hardware 901 is coupled to RAN 610 and 5G network core 630. EDN hardware 901 executes EDN hardware drivers 902, EDN operating systems 903, EDN virtual layer 904, and EDN functions 905 to form EAS 1111, EES 1112, ECS 1113, L4S MEC application 1114, and L4S MEC platform 1115 illustrated in FIG. 11.

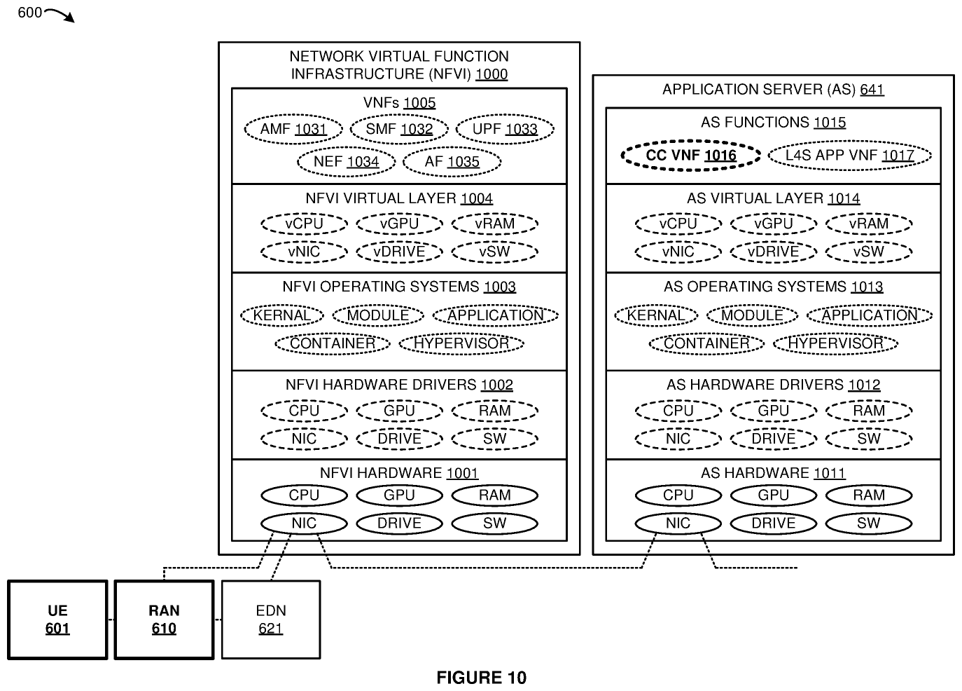

FIG. 10 illustrates Network Function Virtualization Infrastructure (NFVI) 1000 and AS 641. NFVI 1000 comprises an example of core network 121 illustrated in FIG. 1 and network circuitry 330 illustrated in FIG. 3, although core network 121 and network circuitry 330 may differ. NFVI 1000 comprises NFVI hardware 1001, NFVI hardware drivers 1002, NFVI operating systems 1003, NFVI virtual layer 1004, and NFVI VNFs 1005. NFVI hardware 1001 comprises NICs, CPU, GPU, RAM, DRIVE, and SW. NFVI hardware drivers 1002 comprise software that is resident in the NIC, CPU, GPU, RAM, DRIVE, and SW. NFVI operating systems 1003 comprise kernels, modules, applications, containers, hypervisors, and the like. NFVI virtual layer 1004 comprises vNIC, vCPU, vGPU, vRAM, vDRIVE, and vSW. NFVI VNFs 1005 comprise AMF 1031, SMF 1032, UPF 1033, NEF 1034, and AF 1035. Additional VNFs and network elements like Network Repository Function (NRF), Network Slice Selection Function (NSSF), AUSF, PCF, UDM, and Unified Data Repository (UDR) are typically present but are omitted for clarity. NFVI 1000 may be located at a single site or be distributed across multiple geographic locations. The NIC in NFVI hardware 1001 is coupled to RAN 610, the NIC in EDN hardware 901, and to the NIC in AS hardware 1011. NFVI hardware 1001 executes NFVI hardware drivers 1002, NFVI operating systems 1003, NFVI virtual layer 1004, and NFVI VNFs 1005 to form AMF 631, SMF 632, UPF 633, NEF 634, and AF 635.

AS 641 comprises an example of data network 131 illustrated in FIG. 1 and data network 340 illustrated in FIG. 3, although data network 131 and data network 340 may differ. AS 641 comprises AS hardware 1011, AS hardware drivers 1012, AS operating systems 1013, AS virtual layer 1014, and AS functions 1015. AS hardware 1011 comprises NICs, CPU, GPU, RAM, DRIVE, and SW. AS hardware drivers 1012 comprise software that is resident in the NIC, CPU, GPU, RAM, DRIVE, and SW. AS operating systems 1013 comprise kernels, modules, applications, containers, hypervisors, and the like. AS virtual layer 1014 comprises vNIC, vCPU, vGPU, vRAM, vDRIVE, and vSW. AS functions 1015 comprise Congestion Control (CC) VNF 1016 and L4S application (APP) VNF 1017. Additional AS VNFs and network elements are typically present but are omitted for clarity. AS 641 may be located at a single site or be distributed across multiple geographic locations. The NIC in AS hardware 1011 is coupled to the NIC in NFVI hardware 1001 and to external systems. AS hardware 1011 executes AS hardware drivers 1012, AS operating systems 1013, AS virtual layer 1014, and AS functions 1015 to form CC VNF 1116 and L4S application 1117 illustrated in FIG. 11.

FIG. 11 further illustrates EDN 621, NFVI 1000, and AS 641 in 5G communication network 600. AMF 631 performs UE access registration, UE connection management, UE mobility management, and authentication and authorization. SMF 632 performs session establishment and management, UPF selection and control, and network address allocation. UPF 633 performs packet routing and forwarding and QoS handling and PDU serving. NEF 634 performs network capability exposure and BNR reporting. AF 635 performs AS interfacing. EAS 1111 performs edge L4S application hosting and UE L4S application interfacing. EES 1112 performs EEC provisioning, edge event exposure, and 5GC interfacing. ECS 1113 performs EES provisioning, edge registration supporting, and 5GC interfacing. L4S MEC application 1114 performs EAS supporting. L4S MEC platform 1115 performs EES supporting. CC 1116 performs BNR processing and downlink data congestion control. L4S application 1117 performs L4S application service provisioning.

In operation, AMF 631 receives a registration request for UE 601. In response, AMF transfers an identity request for delivery to UE 601. AMF 631 receives an identity indication generated by UE 601 and interacts with other network functions to authenticate the identity of UE 601 and authorize UE 601 for wireless data services. Responsive to the authentication and authorization, AMF 631 retrieve QoS metrics, slice IDs, service attributes, and the like for UE 601. AMF 631 interacts with other network functions to select a network slice for UE 601 and selects SMF 632 to serve UE 601 based on the selected slice ID, the QoS metrics, and the service attributes. SMF 632 selects UPF 633 and indicates the network address for UPF 633 to AMF 631. AMF 631 generates UE context for UE 601 comprising the QoS metrics, the slice ID, the network addresses, the service attributes, and/or other information characterizing the wireless data service for UE 601. AMF 631 transfers the UE context for delivery to UE 601.

AMF 631 receives a session request for an L4S VR PDU session (or some other type of L4S session) generated by UE 601 and forwards the request to SMF 632. For example, UE 601 may execute L4S AC 703 in response to user input and responsively transfer an L4S PDU session request. SMF 632 interfaces with UPF 633, EES 1112, and AS 641 to set up the requested L4S PDU session. EES 1112 selects EAS 1111 based on the requested L4S PDU session type and interfaces with ECS 1113, L4S MEC application 1114, L4S MEC platform 1115, and L4S application 1117 to activate and support the L4S application hosted by EAS 1111. EES 1112 transfers network addresses for EAS 1111 to SMF 632. SMF 632 generates session context that comprises network addresses for EAS 1111, UPF 633, AS 641 and transfers the session context for delivery to UE 601. EAS 1111 exchanges L4S session data with UE 601 over RAN 610. EAS 1111 exchanges the L4S session data with UPF 633. UPF 633 exchanges the L4S session data with L4S application 1117.

During the L4S PDU session, EAS 1111 detects a BNR generated by RAN 610 and received in the uplink data signaling sent by UE 601. The BNR indicates the presence of a downlink data queue, the amount of queued data for UE 601, the current latency and bit rate, and estimated queue time. EAS 1111 forwards the uplink user plane signaling comprising the BNR to UPF 633 for delivery to CC 1116. UPF 633 forwards the uplink user plane signaling comprising the BNR to CC 1116. CC 1116 implements a congestion control algorithm based on the queue information in the BNR. The congestion control algorithm may comprise a BBR algorithm that takes current latency, amount of queued data, queuing delay, and current data bit rate as inputs to generate a congestion response output. For example, CC 1116 may execute the following algorithm:

Congestion Output=(A×Latency)+(B×QueueSize)+(C×DataRate) (1)

where A, B, and C are coefficients to weight the Latency, QueueSize, and DataRate algorithm inputs. It should be appreciated that equation (1) is exemplary and may vary in other examples.

CC 1116 implements the congestion control response based on the algorithm output. In this example, the congestion response comprises instructions to decrease the downlink data transfer to maintain the latency requirements of the L4S session. CC 1116 transfers the congestion control output to EAS 1111. EAS 1111 decreases downlink data transfer to RAN 610 to alleviate data congestion in RAN 610.

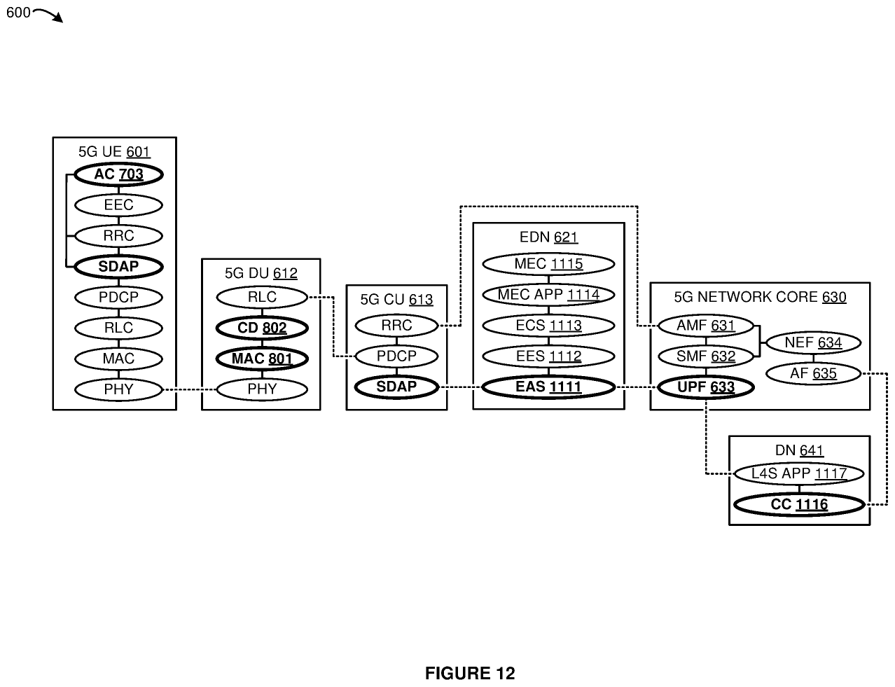

FIG. 12 illustrates an exemplary operation of 5G communication network 600 to inhibit downlink congestion for L4S data services. The operation may vary in other examples. In operation, a user application in UE 601 executes and UE 601 wirelessly attaches to RAN 610. The RRC in UE 601 exchanges attachment signaling with the RRC in CU 613 over the PDCPs, RLCs, MACs, and PHYs. The RRC in CU 613 transfers a registration request comprising a registration type, UE capabilities, requested slice types, and the like to AMF 631. AMF 631 transfers an identity request for UE 601 to the RRC in CU 613. The RRC in CU 613 forwards the identity request to the RRC in UE 601 over the PDCPs, RLCs, MACs, and PHYs. The RRC in UE 601 transfers an identity indication to the RRC in CU 613 over the PDCPs, RLCs, MACs, and PHYs. The RRC in CU 613 forwards the identity indication to AMF 631. AMF 631 interacts with other network functions like AUSF, UDM, and PCF to authenticate and authorize UE 601 for wireless data service.

Responsive to the authentication and authorization, AMF 631 retrieves QoS metrics, allowed slice IDs, service attributes, edge service permissions, and the like. For example, AMF 631 may interface with a UDM to access a subscriber profile for UE 601 and to retrieve the QoS metrics, slice IDs, service attributes, and edge service permissions. AMF 631 selects a network slice for UE 601 and selects SMF 632 to serve UE 601. SMF 632 selects UPF 633 and indicates the network address for UPF 633 to AMF 631. AMF 631 generates UE context that comprises the QoS metrics, the slice ID, the network addresses, the service attributes, and the edge service permissions. AMF 631 transfers the UE context to the RRC in CU 613. The RRC in CU 613 transfers the UE context to the RRC in UE 601 over the PDCPs, RLCs, MACs, and PHYS.

In response to a user input, UE 601 executes L4S AC 703. In response to the execution of L4S AC 703, the RRC in UE 601 transfers an L4S PDU session request to the RRC in CU 613 over the PDCPs, RLCs, MACs, and PHYs. The RRC in CU 613 transfers the request to AMF 621. AMF notifies SMF 632 and SMF 632 controls UPF 633, EES 1112, and AS 641 to set up the requested L4S PDU. EES 1112 selects EAS 1111 based on the L4S PDU session type and interfaces with ECS 1113, L4S MEC application 1114, L4S MEC platform 1115, and L4S application 1117 to activate and support the L4S application hosted by EAS 1111. EES 1112 transfers network addresses for EAS 1111 to SMF 632. SMF 632 generates session context that comprises network addresses for EAS 1111, UPF 633, and AS 641 and indicates the session context to AMF 631. AMF 631 forwards the session to the RRC in CU 613 which in turn forwards the session context to the RRC in UE 601. L4S AC 703 and EAS 1111 generate L4S user data. The SDAP in UE 601 exchanges the L4S user data with the SDAP in CU 613 over the PDCPs, RLCs, MACs, and PHYs. The SDAP in CU 613 exchanges the L4S user data with EAS 1111. EAS 1111 exchanges the L4S user data with L4S application 1117 over UPF 633.

During the L4S PDU session, MAC 801 schedules downlink user data for delivery to UE 601. CD 802 compares the amount of available downlink resource blocks to the amount of required downlink resource blocks to detect the existence of downlink data congestion in RAN 610. When CD 802 detects RAN downlink data congestion, CD 802 determines the amount of queued data, the latency, and the downlink data rate. CD 802 indicates the existence of the data queue, the amount of queued data, the latency, and the downlink data rate to MAC 801. MAC 801 generates a BNR based on the queue measurements and schedules the BNR for wireless transmission to UE 601. MAC 801 transfers the BNR to L4S AC 703 over the PHY in DU 612 and the PHY MAC, RLC, PDCP, and SDAP in UE 601.

L4S AC 703 receives the BNR transferred by MAC 801. When L4S AC 703 detects the BNR, L4S AC 703 generates uplink user data that includes the BNR. For example, L4S AC 703 may indicate the presence of the BNR in a message header in the uplink user data. The SDAP in UE 603 transfers the uplink user data that includes the BNR to the SDAP in CU 613 over the PDCPs, RLCs, MACs, and PHYs. The SDAP in CU 613 transfers the BNR to EAS 1111. EAS 1111 forwards the user plane signaling (including the BNR) to CC 1116 over UPF 633 and L4S application 1117. CC 1116 detects the BNR in the user plane signaling. CC 1116 generates a congestion control response based on the amount of queued data, the latency, and the downlink data rate reported in the BNR. In this example, the congestion control response comprises ceasing downlink data transfer for a period of time and a new downlink data transfer rate. CC 1116 transfers the congestion control response to EAS 1111. EAS 1111 receives the response and ceases downlink data transfer for the specified period of time to clear the queued data in RAN 610. After the specified period of time has elapsed, EAS 1111 generates and transfers additional downlink data for the L4S session at the reduced data rate to inhibit further congestion in RAN 610.

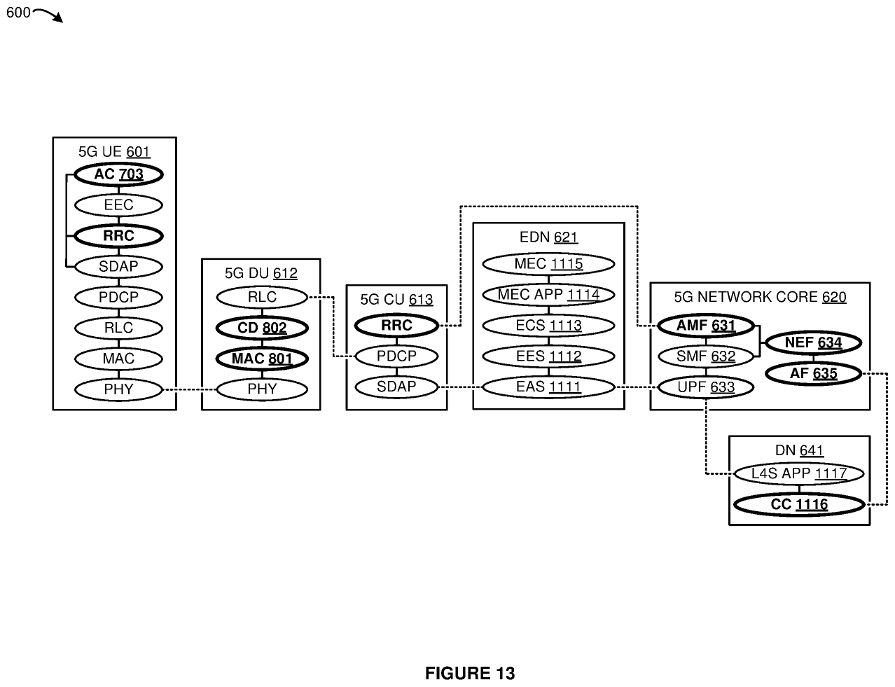

FIG. 13 illustrates an exemplary operation of 5G communication network 600 to inhibit downlink congestion for L4S data services. The operation may vary in other examples. In operation, UE 601 establishes an authenticated connection with network core 630 over RAN 610 as described with respect to FIG. 12. In response to a user input, UE 601 executes L4S AC 703. The RRC in UE 601 detects the execution of L4S AC 703 and transfers an L4S PDU session request to the RRC in CU 613 over the PDCPs, RLCs, MACs, and PHYs. The RRC in CU 613 transfers the request to AMF 621. AMF notifies SMF 632 and SMF 632 directs UPF 633, EES 1112, and AS 641 to set up the requested L4S PDU. EES 1112 transfers network addresses for EAS 1111 to SMF 632. SMF 632 generates and transfers session context for the L4S PDU session to the RRC in CU 613 over AMF 631. The RRC in CU 613 forwards the session context to the RRC in UE 601. The SDAP in UE 601 exchanges the L4S user data with the SDAP in CU 613 over the PDCPs, RLCs, MACs, and PHYs. The SDAP in CU 613 exchanges the L4S user data with EAS 1111. EAS 1111 exchanges the L4S user data with L4S application 1117 over UPF 633.

During the L4S PDU session, MAC 801 schedules downlink user data for delivery to UE 601. CD 802 compares the amount of available downlink resource blocks to the amount of required downlink resource blocks to detect the existence of downlink data congestion in RAN 610. When CD 802 detects RAN downlink data congestion, CD 802 determines the amount of queued data, the latency, and the downlink data rate. CD 802 indicates amount of queued data, the latency, and the downlink data rate to MAC 801. MAC 801 generates a BNR based on the queue measurements and schedules the BNR for wireless transmission to UE 601. MAC 801 transfers the BNR to L4S AC 703 over the PHY in DU 612 and the PHY MAC, RLC, PDCP, and SDAP in UE 601.

L4S AC 703 detects the BNR transferred by MAC 801. L4S 703 determines that it does not know the network location of the congestion control entity responsible for the current L4S session. In response, L4S AC 703 indicates the BNR to the RRC in UE 601. The RRC in UE 601 generates uplink control plane signaling that includes the BNR. The RRC in UE 601 transfers the control plane signaling to the RRC in CU 613 over the PDCPs, RLCs, MACs, and PHYs. The RRC in CU 613 forwards the control plane signaling to AMF 631. AMF 631 detects the BNR in the control plane signaling and drives NEF 634 to expose the BNR to the appropriate congestion control entity. NEF 634 correlates the BNR to CC 1116 and transfers the BNR to CC 1116 over AF 635. CC 1116 receives the BNR exposed by NEF 634. CC 1116 generates a congestion control response based on the amount of queued data, the latency, and the downlink data rate reported in the BNR. In this example, the congestion control response comprises increasing the time interval between downlink data transmissions. CC 1116 transfers the congestion control response to EAS 1111. EAS 1111 receives the response and increases the time between its downlink data transmissions to inhibit further congestion in RAN 610.

The wireless data network circuitry described above comprises computer hardware and software that form special-purpose network circuitry to inhibit downlink RAN congestion for L4S services. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to inhibit downlink RAN congestion for L4S services.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method of operating a wireless access node to inhibit access point data congestion, the method comprising:
wirelessly exchanging user data with a wireless user device for a low latency data service;
exchanging the user data with a network user plane;
measuring a queue status for downlink data transmission to the wireless user device;
generating a queue report that indicates the queue status; and
wirelessly transferring the queue report to the wireless user device wherein the wireless user device receives the queue report and wirelessly transfers uplink signaling indicating the queue report to the wireless access node for delivery to a congestion control application server.

2. The method of claim 1 wherein:
measuring the queue status comprises determining a queue existence; and
the queue status comprises the queue existence.

3. The method of claim 1 wherein:
measuring the queue status comprises determining a queue delay time; and
the queue status comprises the queue delay time.

4. The method of claim 1 wherein:
measuring the queue status comprises determining a queued data amount; and
the queue status comprises the queued data amount.

5. The method of claim 1 wherein:
measuring the queue status comprises determining a downlink data rate; and
the queue status comprises the downlink data rate.

6. The method of claim 1 wherein:
measuring the queue status comprises determining a queue existence, a queue delay time, a queued data amount, a downlink data rate, and a downlink latency; and
the queue status comprises the queue existence, the queue delay time, the queued data amount, the downlink data rate, and the downlink latency.

7. The method of claim 1 wherein:
the wireless access node comprises a Fifth Generation New Radio (5GNR) gNodeB; and further comprising:
executing a Media Access Control (MAC) network application; and
executing a Congestion Detection (CD) network application.

8. A wireless access node to configured to inhibit access point data congestion, the wireless access node comprising:
radio circuitry configured to wirelessly exchange user data with a wireless user device for a low latency data service;
node circuitry configured to exchange the user data with a network user plane;
the node circuitry configured to measure a queue status for downlink data transmission to the wireless user device;
the node circuitry configured to generate a queue report that indicates the queue status; and
the radio circuitry configured to wirelessly transfer the queue report to the wireless user device wherein the wireless user device receives the queue report and wirelessly transfers uplink signaling indicating the queue report to the wireless access node for delivery to a congestion control application server.

9. The wireless access node of claim 8 wherein:
the node circuitry is configured to determine a queue existence; and
the node circuitry configured to generate the queue report that indicates the queue existence.

10. The wireless access node of claim 8 wherein:
the node circuitry is configured to determine a queue delay time; and
the node circuitry is configured to generate the queue report that comprises the queue delay time.

11. The wireless access node of claim 8 wherein:
the node circuitry is configured to determine a queued data amount; and
the node circuitry is configured to generate the queue report that comprises the queued data amount.

12. The wireless access node of claim 8 wherein:
the node circuitry is configured to determine a downlink data rate; and
the node circuitry is configured to generate the queue report that comprises the downlink data rate.

13. The wireless access node of claim 8 wherein:
the node circuitry is configured to determine a queue existence, a queue delay time, a queued data amount, a downlink data rate, and a downlink latency; and
the node circuitry is configured to generate the queue report that comprises the queue existence, the queue delay time, the queued data amount, the downlink data rate, and a downlink latency.

14. The wireless access node of claim 8 wherein:
the wireless access node comprises a Fifth Generation New Radio (5GNR) gNodeB;
the node circuitry is configured to execute a Media Access Control (MAC) network application; and
the node circuitry is configured to execute a Congestion Detection (DC) network application.

15. A method of operating a wireless communication network to inhibit downlink congestion for Low Latency, Low Loss, Scalable (L4S) data services, the method comprising:
a Radio Access Network (RAN) wirelessly exchanging user data with a wireless User Equipment (UE) for a low latency data service and exchanging the user data with a network user plane;
the RAN measuring a queue status for downlink data transmission to the wireless UE, generating a queue report that indicates the queue status, and wirelessly transferring the queue report to the wireless UE;
the wireless UE receiving the queue report and wirelessly transferring uplink signaling indicating the queue report to the RAN for delivery to a congestion control application server;
the RAN receiving the queue report and forwarding the queue report to the congestion control application server; and
the congestion control application server receiving the queue report and implementing a congestion control algorithm based on the queue report.

16. The method of claim 15 wherein:
the RAN measuring the queue status comprises determining a queue existence; and
the queue status comprises the queue existence.

17. The method of claim 15 wherein:
the RAN measuring the queue status comprises determining a queue delay time; and
the queue status comprises the queue delay time.

18. The method of claim 15 wherein:
the RAN measuring the queue status comprises determining a queued data amount; and
the queue status comprises the queued data amount.

19. The method of claim 15 wherein:
the RAN measuring the queue status comprises determining a downlink data rate; and
the queue status comprises the downlink data rate.

20. The method of claim 15 wherein:
the RAN measuring the queue status comprises determining a queue existence, a queue delay time, a queued data amount, a downlink data rate, and a downlink latency; and
the queue status comprises the queue existence, the queue delay time, the queued data amount, the downlink data rate, and the downlink latency.
